(19) United States
(12) Patent Application Publication
(10) Pub. No.: US 2004/0006170 A1
(43) Pub. Date: Jan. 8, 2004

(54) Compositions comprising elastomers and high-molecular-weight polyethylenes with irregular particle shape, process for their preparation, and their use

(76) Inventors: Stanislaw Haftka, Oberhausen (DE); Meinhard Gusik, Oberhausen (DE); Jens Ehlers, Hamminkeln (DE); Kerstin Ludtke, Hamminkeln (DE)

Correspondence Address: Ashley I. Pezzner, Esquire, CONNOLLY BOVE LODGE & HUTZ LLP, 1220 Market Street, P.O. Box 2207, Wilmington, DE, 19899, US

(21) Appl. No.: 10/382,676

(22) Filed: Mar. 6, 2003

(30) Foreign Application Priority Data
Mar. 8, 2002 (DE) 102 10 314.3

(51) Int. Cl. C08F 8/00

(52) U.S. Cl. 524/515; 525/192; 524/525

(57) ABSTRACT

Compositions comprising elastomers and high-molecular-weight polyethylenes with irregular particle shape, process for their preparation, and their use

The compositions described comprise at least one elastomer matrix which has at least one other phase of particles of irregular shape of high- and/or ultrahigh-molecular-weight polyethylenes.

The compositions have high tear propagation resistance and examples of their uses are membranes, gaskets, dampers, and conveyor belts.

### DESCRIPTION

The present invention relates to multiphase elastomer compositions which comprise polyethylene particles with a specific morphology, and which have particular rheology. These compositions may be used in many industrial sectors, for example as rubber membranes, dampers, gaskets, or conveyor belts.

The excellent abrasion resistance and friction performance of ultrahigh-molecular-weight polyethylene (also termed UHMWPE below) have led to their use in rubber mixtures. U.S. Pat. No. 6,187,420 discloses impact-absorbent elastomer mixtures which comprise a crystalline polyolefin, such as an UHMWPE, or a low-density polyethylene, or a polypropylene, and a diene rubber. U.S. Pat. No. 4,735,982 discloses thermoplastic rubber mixtures, which comprise a vulcanized rubber, a UHMWPE, and an abrasion-resistant lubricant. U.S. Pat. No. 6,202,726 moreover describes a pneumatisc tire with selected geometry and comprising a component made from rubber and UHMWPE.

It is also known that the working or processing of high-molecular-weight polyethylenes (also termed HMWPE below) and of ultrahigh-molecular-weight polyethylenes is difficult using traditional plastics processing methods, and that particles of this material may assume various shapes. For example, traditional UHMWPE powders have a regular morphology, i.e. these powders may be represented approximately by a compact spherical shape. One representative of this type with regular or indeed spherical morphology is the product Mipelon 220 from MPC (Mitsui Petrochemicals).

All of the combinations disclosed hitherto of rubbers with HMWPE or with UHMWPE have used particles of HMWPE or UHMWPE with regular morphology.

There are also known high- and ultrahigh-molecular-weight polyethylenes whose shape is that of particles with irregular geometry. These products have low bulk density and are usually porous. Examples of UHMWPE particles of this type are described in WO-A-00/18,810.

It has now been found that multiphase compositions comprising elastomers and particles of high- and/or ultrahigh-molecular-weight polyethylenes with irregular shape have a number of excellent properties, such as improved energy dissipation performance, reflected in a high level of tan δ. It has also is been found that use of HMWPE and, respectively, UHMWPE does not merely, as is known, improve the abrasion resistance and frictional performance of rubber/UHMWPE mixtures but also, surprisingly, improves tear propagation resistance. This behavior is particularly found in the case of powders with irregular morphology.

The present invention provides compositions which have better rheology (high level of tan δ) and very pronounced tear propagation resistance.

The present invention relates to compositions comprising at least one elastomer matrix which has at least one other phase of particles of irregular shape of high- and/or ultrahigh-molecular-weight polyethylenes. The irregular particle shape may be described by way of extremely low bulk density and a correspondingly large specific surface area of the polyethylene powder.

For the purposes of this description, the term “elastomer” means a polymer with elastomeric behavior, preferably having a glass transition temperature below the service temperature.

Examples of preferred elastomers are acrylate rubber (ACM), polyester-urethane rubber (AU), brominated butyl rubber (BIIR), polybutadiene (BR), chlorinated butyl rubber (CIIR), chlorinated polyethylene (CM), epichloro-hydrinhomopolymer (CO), polychloroprene (CR), sulfurated polyethylene (CSM), ethylene-acrylate rubber (EAMY, epichlorohydrin copolymers (ECO), ethylene-propylene copolymers, sulfur-crosslinked or peroxide-crosslinked (EPDM/S, EPDM/P and EPM/P), polyether-urethane rubber (EU), ethylene-vinyl acetate copolymers (EVM), fluorinated rubber (FKM), fluorosilicone rubber (FVMQ), hydrogenated nitrile rubber (H-NBR), butyl rubber (IIR), vinyl-containing dimethylpolysiloxane (VMQ), nitrile rubber (NBR), natural rubber (NR, IR), thioplastics (OT), polyfluorophosphazenes (PNF), polynorbornene (PNR), styrene-butadiene rubber ,(SBR), and nitrile rubber containing carboxy groups (X-NBR).

Very particular preference is given to the use of natural rubber, EPDM, SBR, and NBR.

The term high-molecular-weight polyethylenes is used for polyethylene whose molar mass, measured by viscometry, is at least 3*10⁵ g/mol, in particular from 3*10⁵ to 1*10⁶ g/mol. Ultrahigh-molecular-weight polyethylenes are understood to be polyethylene whose molar mass, measured by viscometry, is at least 1*10⁶ g/mol, in particular from 2.5*10⁵ to 1*10⁷ g/mol. The method for determining molecular weight by viscometry is described by way of example in CZ-Chemische Technik, 4 (1974), p. 129.

Preferred examples of high-molecular-weight polyethylenes, and in particular ultrahigh-molecular-weight polyethylenes, are linear polyethylenes in a very wide variety of forms, but preferably in powder form.

All of the UHMWPE elastomer applications known hitherto have used an UHMWPE with regular morphology. Products with regular or indeed spherical morphology (Mipelon) are obtainable commercially and .are used, inter alia, as additives.

Besides particles with regular or indeed spherical morphology, there are also known HMWPE and UHMWPE particles which have specific irregular morphology. Products comprising these particles have low bulk density, less than 0.35 g/cm³, preferably from 0.01 to 0.32 g/cm³, in particular from 0.10 to 0.30 g/cm³, and very particularly preferably from 0.15 to 0.28 g/cm³, and generally have a porous structure.

The high- or ultrahigh-molecular-weight polyolefins used according to the invention usually have a median particle size D₅₀ of from 1 to 600 μm, preferably from 20 to 300 μm, in particular from 30-200 μm.

The preparation of the particles of high- or ultrahigh-molecular-weight polyolefins used according to the invention is described by way of example in WO-A-00/18,810 or DE-A-1,595,666.

The compositions of the invention may comprise other additives usual in elastomer blend technology.

The compositions of the invention may be prepared by processes which are per se conventional.

The invention also provides the preparation of the compositions defined above, encompassing the steps of:

a) mixing the irregularly shaped particles of high- and/or ultrahigh-molecular-weight polyolefins into the elastomer, where appropriate with other conventional elastomer additives, and

b) vulcanizing the resultant mixture in a manner known per se.

The concentration of the particles of irregular shape in the blends is usually from 1 to 50 phr (parts per 100 parts of rubber), preferably from 5 to 30 phr, in particular from 5 to 20 phr.

The particles of irregular shape and the elastomer form a two-phase blend, the location of the particles of irregular shape being in the dispersed phase. The composition of the invention has high viscosity and toughness, giving the blends improved tear propagation resistance.

The compositions of the invention may be used in many industrial sectors. Preferred application sectors are use as membranes, gaskets, dampers, or conveyor belts.

These uses are likewise provided by the present invention.

### EXAMPLES

The improved rheology, and also the improved tear propagation resistance, are illustrated in the examples below, without limiting the invention. The mixtures prepared were of HMWPE or, respectively, UHMWPE/EPDM or HMWPE or, respectively, UHMWPE/NBR, or HMWPE or, respectively, UHMWPE/SBR. These mixtures are intended to represent the use of HMWPE or, respectively, UHMWPE in an all-round-rubber mixture. The advantageous properties of the compositions of the invention are demonstrated for the HMWPE or, respectively, UHMWPE/SBR mixtures. The HMWPE and UHMWPE used were GUR grades from Ticona GmbH.

### EPDM Mixture Preparation—Mixing Process

The mixtures were prepared in two stages in a Werner & Pfleiderer GK1,5 E laboratory internal mixer (stage 1: base mixture; stage 2: mixing-in of other constituents of the mixture)

Mixing parameters (stage 1)

EPDM mixing parameters

| | | |
|---|---|---|
| Fill level: | 75% | 75% |
| Preliminary temperature setting: | 60° C. | 40° C. |
| Rotor rotation rate: | 80 rpm | 40 rpm |
| Batch temperature: | max. 151-156° C. | max. 117° C. |

| | |
|---|---|
| Mixing cycle: | 0.0-0.5 minutes: polymer |
| | 0.5-1.5 minutes: ½ carbon black, |
| | GUR powder, zinc oxide, stearic acid |
| | 1.5-5.0 minutes: ½ carbon black, |
| | plasticizer oil |
| Total mixing time: | 5.0 minutes (effective) - purging and |
| | aeration after 4.0 minutes |

Mixing parameters (stage 2)

The base mixtures were heated using an initial temperature of 70° C. and a rotor rotation rate of 80-100 rpm, to a temperature of about 130-140° C. It was only when these temperatures had been reached that the ram settled, i.e. the mixtures became plastic and therefore processable. The rotor rotation rate was then reduced to 60 rpm, and sulfur/accelerator was mixed in over a period of 45 seconds. The temperatures on ejection of the mixtures were between about 110 and about 130° C., depending on the GUR grade and the GUR concentration. The kneader fill level was 65%.

### Preparation Of Mixture For SBR And, Respectively, NBR Mixing Process

The mixtures were prepared in a Werner & Pfleiderer GK1.5 E laboratory internal mixer. Sulfur and vulcanization accelerator were then admixed on a laboratory roll mill.

Mixing parameters for internal mixer

| | |
|---|---|
| Fill level: | 75%. |
| Preliminary temperature setting: | 40° C. |
| Rotor rotation rate: | 50 rpm |
| Batch temperature: | max. 137-138° C. |
| Mixing cycle: | 0.0-1.0 minutes: polymer |
| | 1.0-2.5 minutes: ¾ carbon black, |
| | GUR powder, zinc oxide, stearic |
| | acid, antioxidants, coumarone resin |
| | 2.5-4.5 minutes: ¼ carbon black, |
| | plasticizer (Vestinol AH) |
| Total mixing time: | 4.5 minutes (effective) - purging and |
| | aeration after 3.5 minutes |

Mixing parameters for roll mill

| | |
|---|---|
| Roll temperature: | 50° C. |
| Roll rotation rate: | 16:20 rpm |
| Mixing cycle: | 0.0-1.0 minutes: base mixture from |
| | intemal mixer |
| | 1.0-5.0 minutes: sulfur and |
| | vulcanization accelerator |

### Vulcanization

The mixtures were vulcanized at 160° C. (SBR and NBR) or 170° C. (EPDM). The vulcanization times were t₉₀+1 minute per mm of test specimen thickness.

### EPDM Mixing Specifications

A 65 Shore A standard mixture was used with an accelerator system adjusted to be free from nitrosamine.

| | EPDM | EPDM | EPDM | EPDM | EPDM |
|---|---|---|---|---|---|
| | Control | 2126-5 | 2126-10 | 4186-5 | 4186-10 |
| EPDM, 55% ethylene, | 100.0 | 100.0 | 100.0 | 100.0 | 100.0 |
| 4% ENB | | | | | |
| GUR2126 | — | 5.0 | 10.0 | — | — |
| GUR4186 | — | — | — | 5.0 | 10.0 |
| N 550 carbon black | 100.0 | 100.0 | 100.0 | 100.0 | 100.0 |
| RS zinc oxide | 5.0 | 5.0 | 5.0 | 5.0 | 5.0 |
| Stearic acid | 1.0 | 1.0 | 1.0 | 1.0 | 1.0 |
| Plasticizer, paraffinic | 50.0 | 50.0 | 50.0 | 50.0 | 50.0 |
| Sulfur, 95% purity | 0.7 | 0.7 | 0.7 | 0.7 | 0.7 |
| DTDC accelerator | 1.0 | 1.0 | 1.0 | 1.0 | 1.0 |
| ZTDP accelerator | 1.2 | 1.2 | 1.2 | 1.2 | 1.2 |
| MBT accelerator | 0.7 | 0.7 | 0.7 | 0.7 | 0.7 |
| CBS accelerator | 1.0 | 1.0 | 1.0 | 1.0 | 1.0 |

### SBR Mixing Specifications

SBR mixing specifications

| | SBR Control | SBR 2126-5 | SBR 2126-10 | SBR 2126-20 |
|---|---|---|---|---|
| E-SBR, 23% styrene, | 137.5 | 137.5 | 137.5 | 137.5 |
| 37.5 phr arom. mineral | | | | |
| oil | | | | |
| GUR2126 | — | 5.0 | 10.0 | 20.0 |
| N 234 carbon black | 50.0 | 50.0 | 50.0 | 50.0 |
| RS zinc oxide | 3.0 | 3.0 | 3.0 | 3.0 |
| Stearic acid | 2.0 | 2.0 | 2.0 | 2.0 |
| 6PPD antioxidant | 2.0 | 2.0 | 2.0 | 2.0 |
| TMQ antioxidant | 1.0 | 1.0 | 1.0 | 1.0 |
| Microwax light stabilizer | 2.0 | 2.0 | 2.0 | 2.0 |
| Sulfur | 1.75 | 1.75 | 1.75 | 1.75 |
| CBS accelerator | 1.0 | 1.0 | 1.0 | 1.0 |
| DPG accelerator | 0.4 | 0.4 | 0.4 | 0.4 |
| SBR1712 | 137.5 | 137.5 | 137.5 | 137.5 |
| GUR4186 | 5.0 | 10.0 | 20.0 | — |
| GUR4150 | — | — | — | 10.0 |
| N 234 carbon black | 50.0 | 50.0 | 50.0 | 50.0 |
| RS zinc oxide | 3.0 | 3.0 | 3.0 | 3.0 |
| Stearic acid | 2.0 | 2.0 | 2.0 | 2.0 |
| 6PPD antioxidant | 2.0 | 2.0 | 2.0 | 2.0 |
| TMQ antioxidant | 1.0 | 1.0 | 1.0 | 1.0 |
| Microwax light | 2.0 | 2.0 | 2.0 | 2.0 |
| stabilizer | | | | |
| Sulfur | 1.75 | 1.75 | 1.75 | 1.75 |
| CBS accelerator. | 1.0 | 1.0 | 1.0 | 1.0 |
| DPG accelerator | 0.4 | 0.4 | 0.4 | 0.4 |

### NBR Mixing Specification

NBR mixing specification

| | NBR Control | NBR 2126-10 | NBR 4186-10 |
|---|---|---|---|
| NBR, 33% acrylonitrile | 100.0 | 100.0 | 100.0 |
| GUR2126 | — | 10.0 | — |
| GUR4186 | — | — | 10.0 |
| N 330 carbon black | 40.0 | 40.0 | 40.0 |
| Zinc oxide | 5.0 | 5.0 | 5.0 |
| Stearic acid | 1.0 | 1.0 | 1.0 |
| ZMMBI antioxidant | 1.0 | 1.0 | 1.0 |
| Subst. phenylamine | 1.0 | 1.0 | 1.0 |
| antioxidant | | | |
| Cumarone resin 75 | 5.0 | 5.0 | 5.0 |
| DOP plasticizer | 10.0 | 10.0 | 10.0 |
| Sulfur, insoluble | 1.5 | 1.5 | 1.5 |
| MBTS accelerator | 1.8 | 1.8 | 1.8 |
| DPG accelerator | 0.5 | 0.5 | 0.5 |

### Example 1

### Tear Propagation Resistance of SBR/GUR Mixtures

GUR grades with irregular morphology and GUR grades with regular morphology were used for the blends described above. The products also differed in median particle size and molecular weight. Tear propagation resistance to DIN 53507 A was measured on all of the mixtures.

The table below lists the properties of the particles, and also the results of testing

| GUR | None | Grade 1 | Grade 2 | Grade 3 | Grade 4 | Grade 5 | Grade 6 |
|---|---|---|---|---|---|---|---|
| Morphology | — | regular | regular | irregular | irregular | irregular | irregular |
| D₅₀ (μm) | — | 60 | 130 | 30 | 60 | 120 | 120 |
| M_{W} (g/mol) | — | 6 m | 6 m | 4 m | 4 m | 4 m | 0.25 m |
| Bulk density | — | 0.42 | 0.42 | 0.26 | 0.24 | 0.24 | 0.24 |
| BD (g/cm³) | | | | | | | |
| Tear | 11.5 ± | 16.4 ± | 16.8 ± | 20.5 ± | 19.2 ± | 20.0 ± | 18.0 ± |
| propagation | 0.2 | 0.7 | 0.7 | 1.0 | 1.0 | 0.9 | 2.3 |
| resistance | | | | | | | |
| (N/mm) | | | | | | | |

The increase in static tear propagation resistance in the case of the irregular GUR grades can be explained through dissipation of stress, since when the tear encounters the GUR particles the stresses become divided. The effect of increasing the tear propagation resistance is in turn most pronounced in the case of the irregular GUR grades. This is probably a result of the large particle volume of these products.

### Example 2

### Improved Energy Dissipation In SBR/GUR Mixtures With 30 μm MPS (Middle Particle Size)

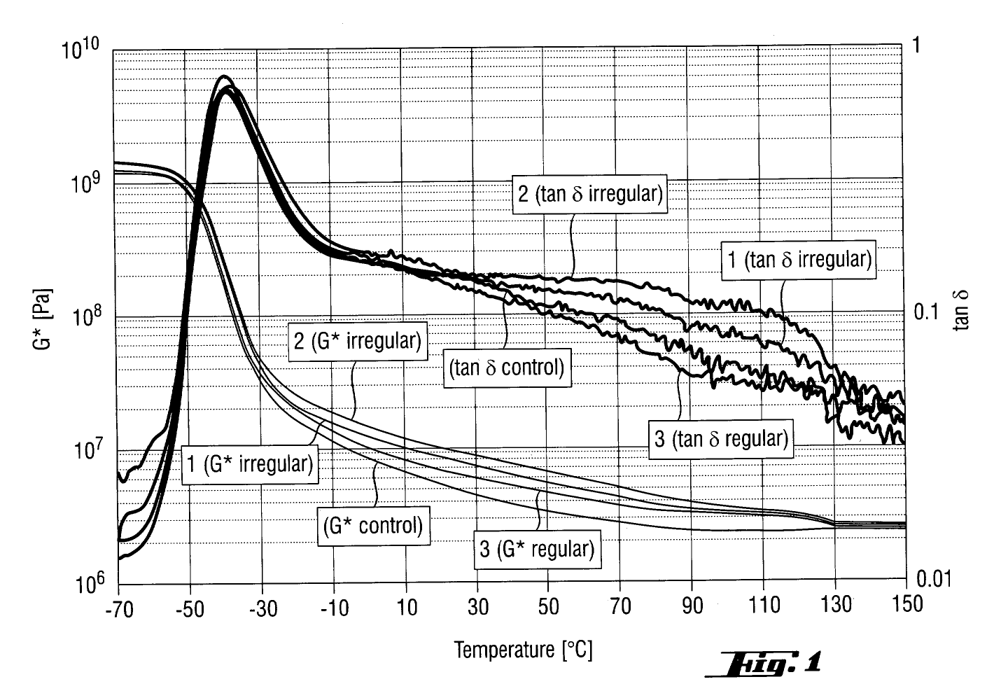

Dynamic shear modulus measurements at frequency 1 Hz and 0.5% deformation were carried out as a function of temperature on SBR/GUR mixtrues with various GUR morphologies (particles of regular and of irregular shape). FIG. 1 illustrates the temperature dependencies of the shear moduli and loss angles (tan δ) for selected compounds.

When GUR particles of regular shape are used (curves 3), no pronounced effect on damping performance (tan δ) was found alongside the increase in modulus over the control mixture.

If GUR particles of irregular shape fare used, a concentration as low as 10 phr brought about an increase in tan δ in the temperature range from 30-120° C., alongside the increase in modulus (cf. curve 1). The shape of the tan δ curve for the 20 phr vulcanizate clearly shows that this effect is systematic (cf. curve 2). The values of tan δ have been raised to a level which reflects the doubling of concentration. The reason for this different behavior lies in the different morphology and different compressibility of the GUR powder with irregular morphology. The porous particle structure permits the GUR with particles of irregular shape used as a blend component to absorb energy under dynamic stress, and this is reflected in an additional, broad tan δ maximum. Products with different particle size exhibit different levels of this behavior.

1. Compositions comprising at least one elastomer matrix which has at least one other phase of particles of irregular shape of high- and/or ultrahigh-molecular-weight polyethylenes.

2. Compositions according to claim 1, characterized in that the elastomer is selected from the group consisting of acrylate rubbers (ACM), polyester-urethane rubber (AU), brominated butyl rubber (BIIR), polybutadiene (BR), chlorinated butyl rubber (CIIR), chlorinated polyethylene (CM), epichloro-hydrinhomopolymer (CO), polychloroprene (CR), sulfurated polyethylene (CSM), ethylene-acrylate rubber (EAM), epichlorohydrin copolymers (ECO), ethylene-propylene copolymers, sulfur-crosslinked or peroxide-crosslinked (EPDM/S, EPDM/P and EPM/P), polyether-urethane rubber (EU), ethylene-vinyl acetate copolymers (EVM), fluorinated rubber (FKM), fluorosilicone rubber (FVMQ), hydrogenated nitrile rubber (H-NBR), butyl rubber (IIR), vinyl-containing dimethylpolysiloxane (VMQ), nitrile rubber (NBR), natural rubber (NR, IR), thioplastics (OT), polyfluorophosphazenes (PNF), polynorbornene (PNR), styrene-butadiene rubber (SBR), and nitrile rubber containing carboxy groups (X-NBR).

3. Compositions according to claim 2, characterized in that the elastomer is selected from the group consisting of natural rubber, EPDM, SBR and NBR.

4. Compositions according to claim 1, characterized in that the polyethylene is a ultrahigh-molecular-weight polyethylene (UHMWPE).

5. Compositions according to claim 1, characterized in that these comprise irregular particles with a porous structure and having a bulk density of less than 0.35 g/cm³.

6. Compositions according to claim 1, characterized in that these comprise irregular particles whose particle size is from 1 to 600 μm, preferably from 20 to 300 μm, in particular from 30 to 200 μm.

7. A process for preparing the compositions according to claim 1, encompassing the steps of:
a) mixing the irregularly shaped particles of high- and/or ultrahigh-molecular-weight polyethylene into an elastomer, where appropriate with other conventional elastomer additives, and
b) vulcanizing the resultant mixture in a manner known per se.

8. Use of the compositions according to claim 1 as membranes, gaskets, dampers, or conveyor belts.
